(19) United States
(12) Patent Application Publication
(10) Pub. No.: US 2016/0096188 A1
(43) Pub. Date: Apr. 7, 2016

(54) Conduit Treatment System

(71) Applicant: Jeffrey M. Tanner, Zanesville, OH (US)

(72) Inventor: Jeffrey M. Tanner, Zanesville, OH (US)

(21) Appl. No.: 14/508,447

(22) Filed: Oct. 7, 2014

(51) Int. Cl. B05C 7/08; B05D 1/28; B05C 1/02; B05D 7/22

(52) U.S. Cl. CPC B05C 7/08; B05D 7/222; B05D 1/28; B05C 1/027

(57) ABSTRACT

A conduit treatment system for uniformly apply coatings or treatments to the inner walls of conduits without excessive build-up or creation of blockages. The conduit treatment system generally includes a tube having an absorbent first layer and a non-absorbent second layer. When not inverted, the first layer is the interior of the tube and the second layer is the exterior of the tube. The first layer will be adapted to absorb a treatment which is to be applied within a conduit. By securing a tether between an inversion unit and a closed-off end of the tube, the tube may be wound onto the inversion unit's shaft. The first end of the tube may then be anchored to the inversion unit's connector head to allow for inversion of the tube within a conduit. Upon inversion, the first layer will apply its absorbed treatment to the inner walls of the conduit.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a treatment system and more specifically it relates to a conduit treatment system for uniformly apply coatings or treatments to the inner walls of pipes or conduits without excessive build-up or creation of blockages.

2. Description of the Related Art

Any discussion of the related art throughout the specification should in no way be considered as an admission that such related art is widely known or forms part of common general knowledge in the field.

Despite widespread use, the options available for coating or treating the inside of a pipe or conduit are very limited. One option is to utilize spraying nozzles connected to a supply hose that is then pushed or pulled through the pipe or conduit. The supply hose is connected to a pressure unit that delivers the solution through the hose, which delivers it to the spray nozzle or nozzles. The spray nozzle, or nozzles, spray the treatment or coating onto the inside walls of the pipe or conduit.

The problem with this type of application is that it can be very difficult to apply the coating or treatment solution consistently throughout the pipe or conduit. The solution can become very unevenly distributed onto the inside walls of the pipe or conduit. This can cause uncoated or untreated areas within the pipe or conduit.

Excessive solution can cause heavy buildup on the inside walls of the pipe or conduit, which can cause the solution to run down the side walls and accumulate in the bottom of the pipe or conduit. Also, nozzles can become clogged with the solution and can cause intermittent application of the solution. This also causes extra labor due to the nozzles consistently needing cleaned.

Yet another option is to blow or vacuum the coating or treatment solution through the pipe or conduit using air pressure. The solution is blown through an entry point of the pipe or conduit utilizing an air compressor type unit that feeds the solution into the pipe or conduit, and then forces the solution through the pipe or conduit until it reaches the exit point. The problem with this type of application is that it can be very difficult to regulate the pressure or vacuum being used, therefore the solution thickness is not consistent. Also, the solution can cause a blockage if it is not blown all the way through the pipe or conduit. Because of the inherent problems with the related art, there is a need for a new and improved conduit treatment system for uniformly apply coatings or treatments to the inner walls of pipes or conduits without excessive build-up or creation of blockages.

### BRIEF SUMMARY OF THE INVENTION

The invention generally relates to a conduit treatment system which includes a tube having a first layer formed of an absorbent material and a second layer formed of a non-absorbent material. When not inverted, the first layer will represent the interior of the tube while the second layer will represent the exterior of the tube. The absorbent material on the first layer will be adapted to be coated with and absorb a treatment such as a seal, coating, paint, or the like which is to be applied within a conduit. By securing a tether between an inversion unit and a closed-off second end of the tube, the tube and tether may be wound onto a shaft of the inversion unit. The first end of the tube may then be anchored to a connector head on the inversion unit to allow for inversion of the tube within a conduit. Upon inverting within the conduit, the first layer will invert to apply its absorbed treatment to the inner walls of the conduit.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of a tube of the present invention in a non-inverted state.

FIG. 2 is an upper perspective view of a treatment being inserted into the tube of the present invention.

FIG. 3 is a top cutaway view of a tube of the present invention after being coated with treatment.

FIG. 4 is a top cutaway view of a tube of the present invention with its second end tied off by a tether.

FIG. 5 is a side view of the tube of the present invention aligned to be wound within an inversion unit.

FIG. 6 is a side view of the tether of the present invention being wound onto the shaft of an inversion unit.

FIG. 7 is a side cutaway view of the present invention ready for use.

FIG. 8 is a side cutaway view of the present invention at the start of the inversion process.

FIG. 9 is a side cutaway view of the present invention as the tube is being inverted within a conduit.

FIG. 10 is a side cutaway view of the tube being retracted from the conduit under pressure.

FIG. 11 is a side cutaway view of the tube after retraction from the conduit.

FIG. 12 is a frontal sectional view of the tube of the present invention within a conduit.

FIG. 13 is a frontal sectional view of the tube being inverted within a conduit.

FIG. 14 is a frontal sectional view of the conduit during treatment.

FIG. 15 is a frontal sectional view of the conduit after treatment has been completed.

FIG. 16 is a flowchart illustrating preparation of the present invention for inversion.

FIG. 17 is a flowchart illustrating the inversion and treatment processes of the present invention.

### DETAILED DESCRIPTION OF THE INVENTION

### A. Overview.

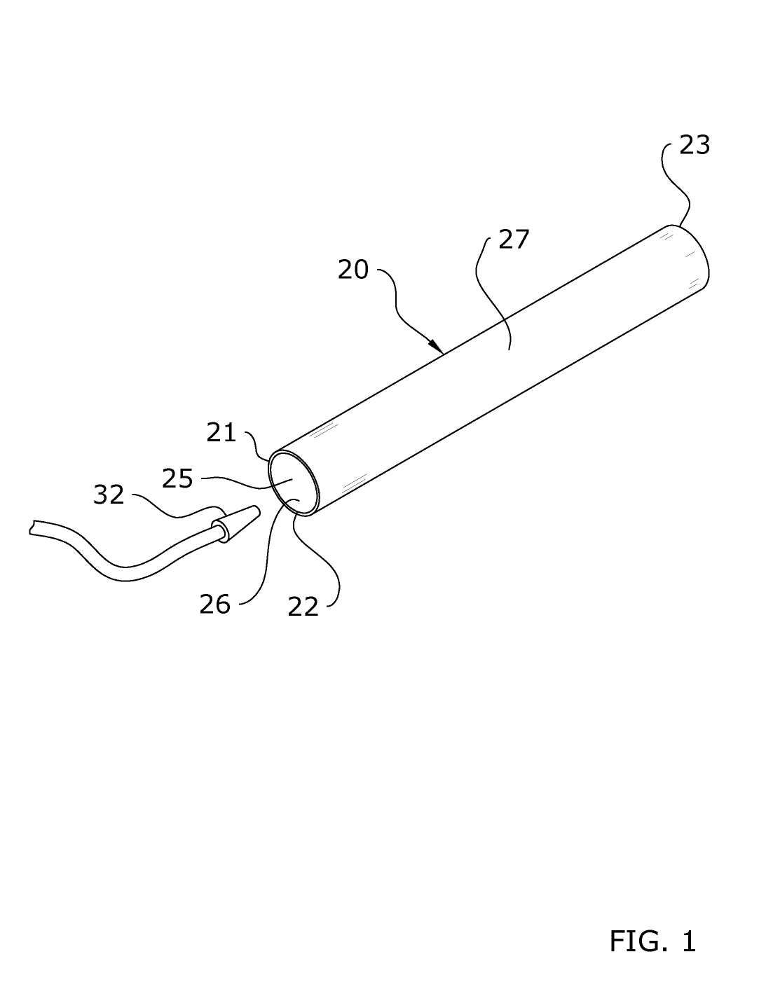

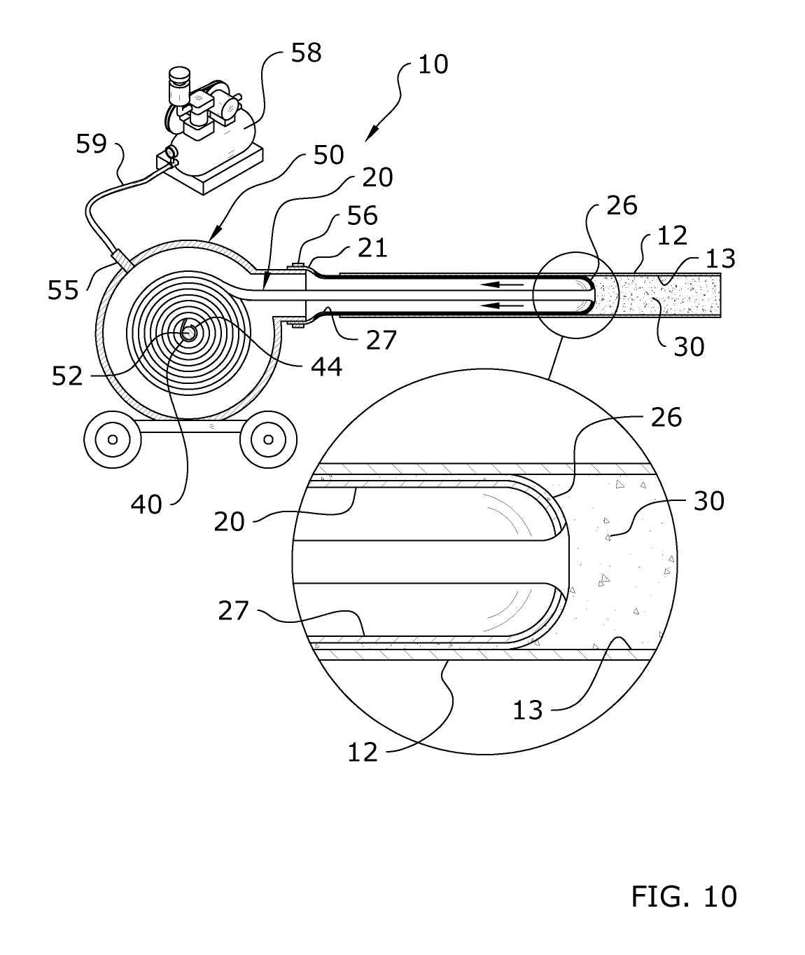

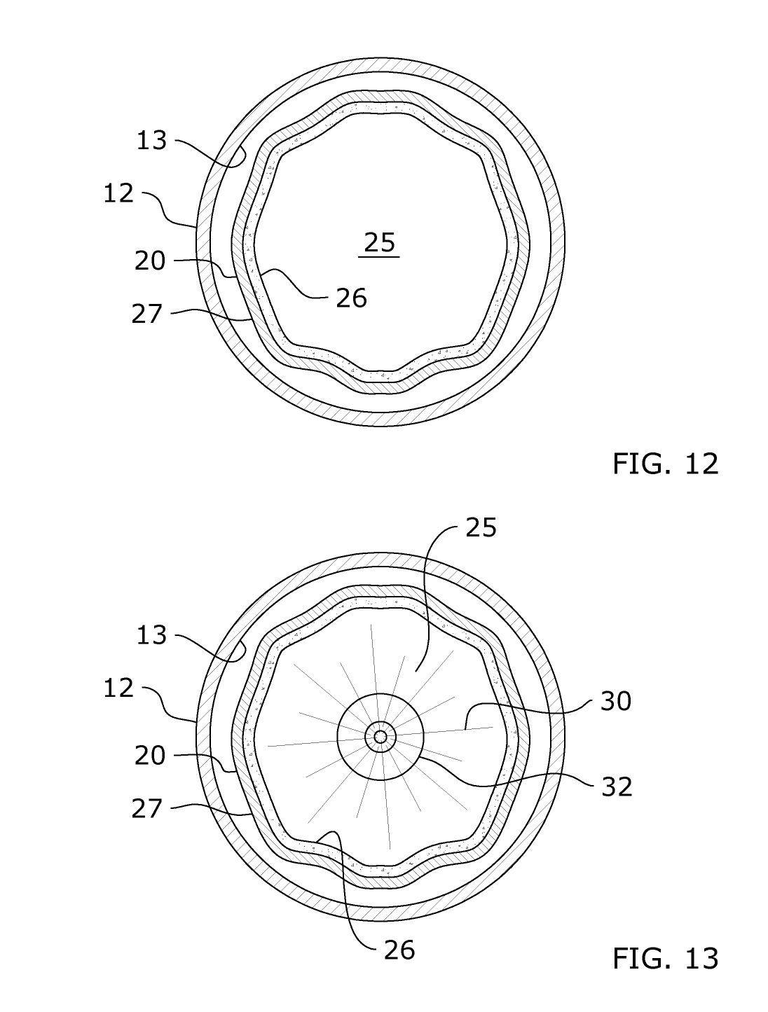

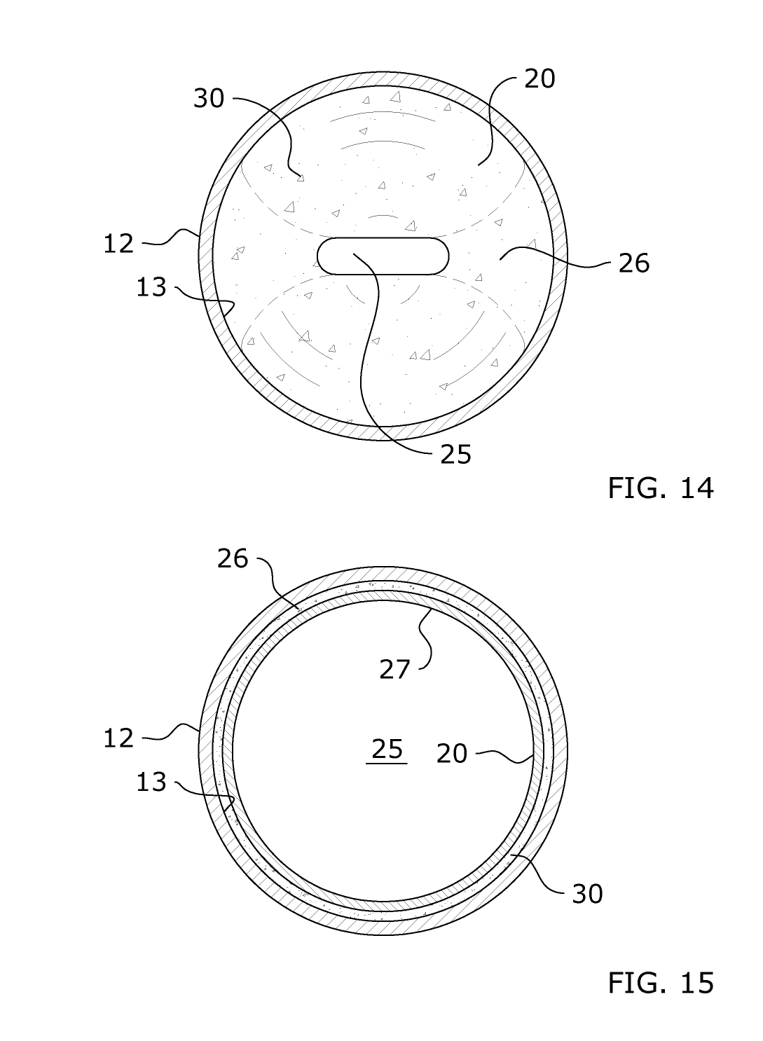

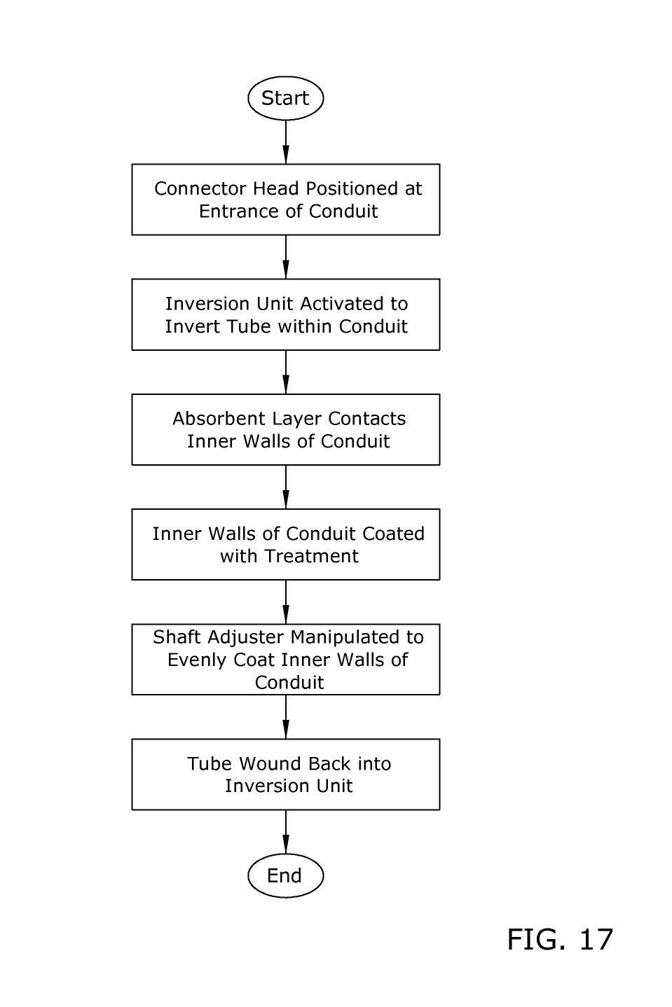

Turning now descriptively to the drawings, in which similar reference characters denote similar elements throughout the several views, FIGS. 1 through 17 illustrate a conduit treatment system 10, which comprises a tube 20 having a first layer 26 formed of an absorbent material and a second layer 27 formed of a non-absorbent material that is preferably impregnable. When not inverted, the first layer 26 will represent the interior of the tube 20 while the second layer 27 will represent the exterior of the tube 20. The absorbent material on the first layer 26 will be adapted to be coated with and absorb a treatment 30 such as a seal, coating, paint, or the like which is to be applied within a conduit 12. By securing a tether 30 between an inversion unit 50 and a closed-off second end 23 of the tube 20, the tube 20 and tether 30 may be wound onto a shaft 52 of the inversion unit 50. The first end 21 of the tube 20 may then be anchored to a connector head 54 on the inversion unit 50 to allow for inversion of the tube 20 within a conduit 12. Upon inverting within the conduit 12, the first layer 26 will invert to apply its absorbed treatment 30 to the inner walls 13 of the conduit 12.

### B. Tube.

As shown throughout the figures, the present invention includes a tube 20 which is inverted within a conduit 12 to coat the inner walls 13 of the conduit 20. The tube 20 will generally comprise a tubular, elongated member having a first end 21 and a second end 23. The first end 21 includes a first opening 22 and the second end 23 includes a second opening 24. A channel 25 extends between the first and second openings 22, 24 of the tube 20.

FIGS. 1-4 illustrate an exemplary embodiment of a tube 20 for use with the present invention. It should be appreciated that the shape, size, and configuration of the tube 20 may vary in different embodiments of the present invention. The length and width of the tube 20 will vary depending on the size of the conduit 12 being treated. The shape or cross-section of the tube 20 may also vary in different embodiments, though a cylindrical tube 20 having a circular cross-section is preferred to ensure uniform distribution of the treatment solution 30 within the conduit 12.

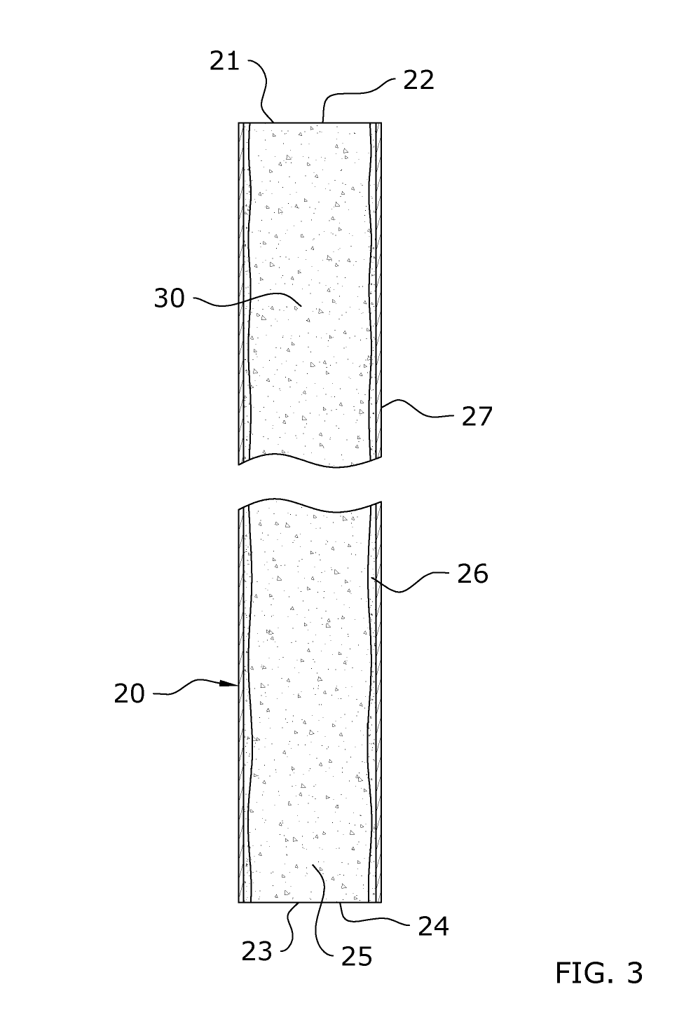

As best shown in FIG. 3, the tube 20 generally includes at least a first layer 26 and a second layer 27. When not inverted, the first layer 26 comprises the inner layer of the tube 20 which faces in toward the channel 25. The second layer 27 comprises the outer layer of the tube 20 which encompasses the outer surfaces of the tube 20 when it is not inverted, such as shown in FIG. 3.

As shown in FIG. 3, the first layer 26 and the second layer 27 will preferably comprise different materials. The first layer 26, which comprises the inner layer of the tube 20 when not inverted, generally comprises an absorbent material. The second layer 27, which comprises the outer layer of the tube 20 when not inverted, generally comprises a flexible membrane made of a non-absorbent material. In preferred embodiments, the second layer 27 will comprise an impregnable material.

A preferred material for the first layer 26 would be materials utilized with common paint rollers. Exemplary materials may include (but are not limited to) fleece, polyester textiles, synthetic fibers, natural fibers, foam materials, and the like. The scope of the present invention should not be limited to these particular materials, as the first layer 26 may comprise any absorbent material capable of absorbing the treatment solution 30.

The second layer 27 comprises a membrane or material which does not absorb the treatment 30 and does not allow the treatment 30 to pass therethrough. The second layer 27 preferable comprises a non-absorbent material. The membrane or material of the second layer 27 is preferably impregnable to prevent leakage from the first layer 26. A wide range of materials may be utilized for the second layer 27, such as PVC, polyurethane, and other plastics.

The respective depths of the layers 26, 27 may vary in different embodiments. The figures should not be construed as limiting in this respect. In some embodiments, the first layer 27 will be thicker so as to absorb more of the treatment 30. In other embodiments, where only a thin layer of treatment 30 is desired, the first layer 27 could be narrower. Thus, any ratio of thicknesses with respect to the layers 26, 27 may be utilized with the present invention.

It should also be appreciated that the layers 26, 27 may be connected together to form the tube 20 in a variety of manners. The layers 26, 27 may be secured to each other, such as via a fastener, sewing or adhesives. Alternatively, the second layer 27 could in some embodiments be applied to the first layer 26 in a liquid form and allowed to dry or cure to form the two-layer configuration shown in the figures. The layers 26, 27 may in some embodiments be integrally formed with the tube 20.

### C. Treatment.

The present invention utilizes treatment 30 which saturates the first layer 26 of the tube 20, which is adapted to absorb the treatment 30 in such a manner which will allow the treatment 30 to be evenly coated along the inner walls 13 of a conduit 12. The treatment 30 will preferably be stopped by the second layer 27, which will be non-absorbent and preferably impregnable to prevent the treatment 30 from seeping through to the second layer 27 of the tube 20.

The present invention is adapted for use with a wide range of treatments 30 adapted to treat the inner walls 13 of a conduit 12, such as for cleaning, painting, sealing, or other uses. The treatment 30 could comprise solutions or coatings which will be absorbed by the first layer 26 of the tube 20 prior to being distributed within the inner walls 13 of the conduit 12 as the tube 20 is inverted as discussed herein. Treatments 30 for use with the present invention include, by way of example and without limitation, epoxies, resins, paints, rust converters, sealers, treatment inhibitors, and the like.

It should be appreciated that the method utilized to saturate or coat the first layer 26 of the tube 20 may vary in different embodiments. The figures illustrate a treatment applicator 32 comprised of a spray nozzle being utilized to spray the treatment 30 into the tube 20 when in a non-inverted state. A wide range of treatment applicators 32 may be utilized, including hoses, spray nozzles, or simply containers which are poured into the tube 20. The treatment 30 could be introduced into the tube 20 by such methods as injection, pouring, spraying, or any other method which will adequately saturate the first layer 26 of the tube 20 for use with the present invention.

### D. Tether.

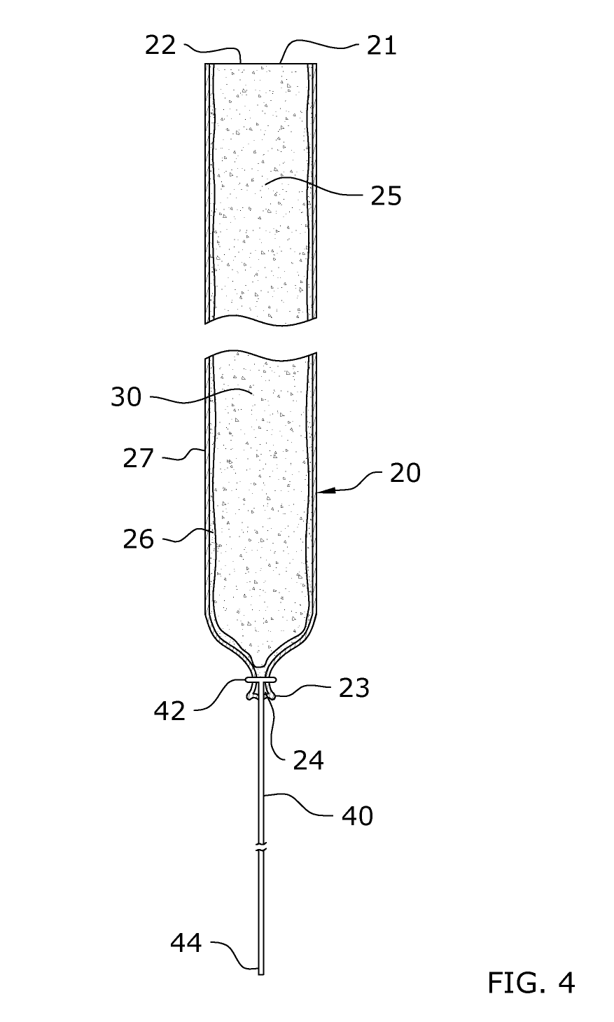

As best shown in FIG. 4, the present invention utilizes a tether 40 which is utilized to tie off the second end 23 of the tube 20 to close the second opening 24 after the treatment 30 has saturated the first layer 26 of the tube 20. The manner in which the tether 40 ties off the second end 23 of the tube 20 may vary widely in different embodiments, including the use of knots, clamps, adapters, ring members, and the like.

Any method which adequately ties off the second end 23 of the tube 20 to close its second opening 24 may be utilized with the present invention. In some embodiments, a tether 40 may be omitted for the purpose of tying off the second end 23 of the tube 20. For example, in some embodiments, the tube 20 could have a closed second end 23 which does not require a separate tether 40 or other device for tying off. However, a tether 40 will generally be required for the purpose of anchoring the second end 23 of the tube 20 with the shaft 52 of the inversion unit 50 as described herein to enable the inversion process.

The tether 40 will generally comprise a flexible, elongated member adapted to tie off the second end 23 of the tube 20 as shown in the figures. The tether 40 is preferably flexible so as to allow the tether 40 to be rolled onto the shaft 52 of the inversion unit 50 prior to inversion.

In a preferred embodiment, the tether 40 will comprise a rope having a first end 42 adapted to tie off the second end 23 of the tube 20. The second end 44 of the tether 40 will be adapted to be secured to the shaft 52 of the inversion unit 50 so that the tether 40 may be rolled onto the shaft 52 in preparation for inversion. It should be appreciated that the manner in which the tether 40 is secured to the shaft 52 may vary in different embodiments, such as by tying the tether 40 onto the shaft 52 or otherwise securing the tether 40 (such as by a clamp or other device). In some embodiments, the tether 40 could be integrally formed with the shaft 52 or secured thereto by adhesive or other methods.

### E. Inversion Unit.

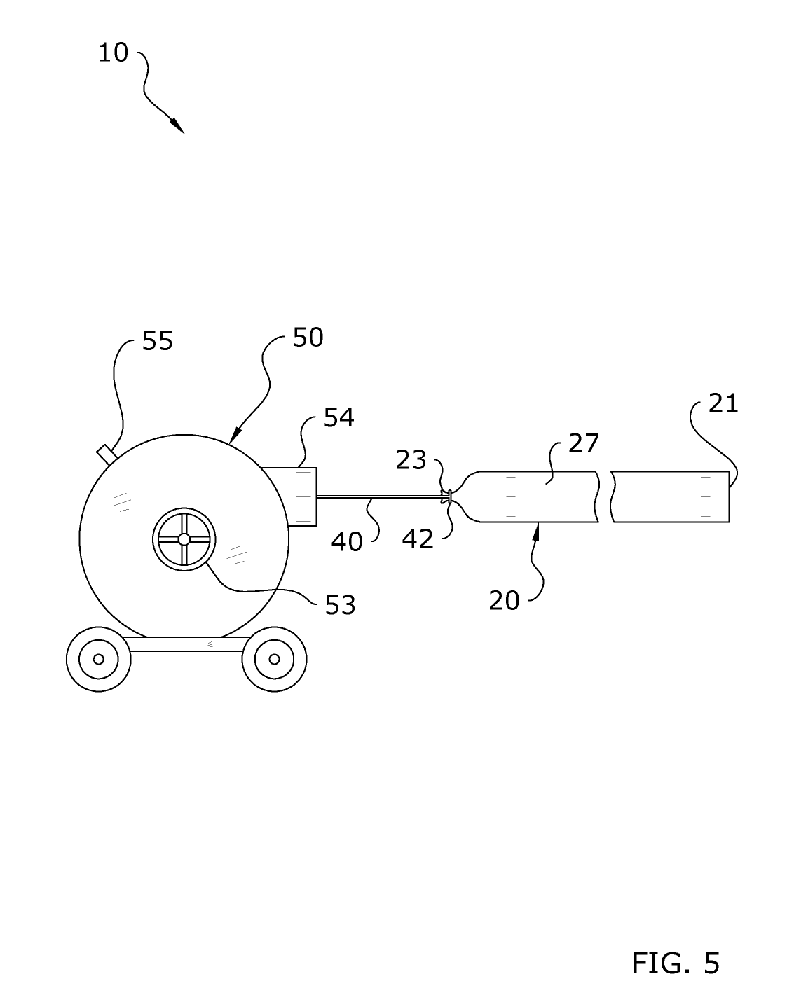

As best shown in FIG. 5, an inversion unit 50 is included with the present invention to aid in inverting the tube 20 to distribute the treatment 30 within the conduit 12. The structure, shape, size, and configuration of the inversion unit 50 may vary in different embodiments, and thus the scope of the present invention should not be construed as limited by the exemplary inversion unit 50 embodiment shown in the figures.

The figures illustrate a conventional inversion unit 50 commonly used with pipe lining and similar processes. The inversion unit 50 is generally free-standing and easily transportable, such as through usage of wheels. The interior of the inversion unit 50 includes a shaft 52 onto which the tether 40 and tube 20 will be wound prior to inversion. The inversion unit 50 may include an air supply inlet 55 adapted to be connected to a source of compressed air.

An air compressor 58 will typically provide air pressure to the inversion unit 50 as shown in the figures. Various types of air compressors 58 may be utilized, and the scope of the present invention should not be construed as being limited to any particular type or configuration of air compressor 58. In some embodiments, the inversion unit 50 may be integrated with a built-in air compressor 58 to provide the compressed air for use with the inversion process. In embodiments in which an external air compressor 58 is utilized, an air hose 59 may be utilized to connect the air compressor 58 with the inversion unit 50.

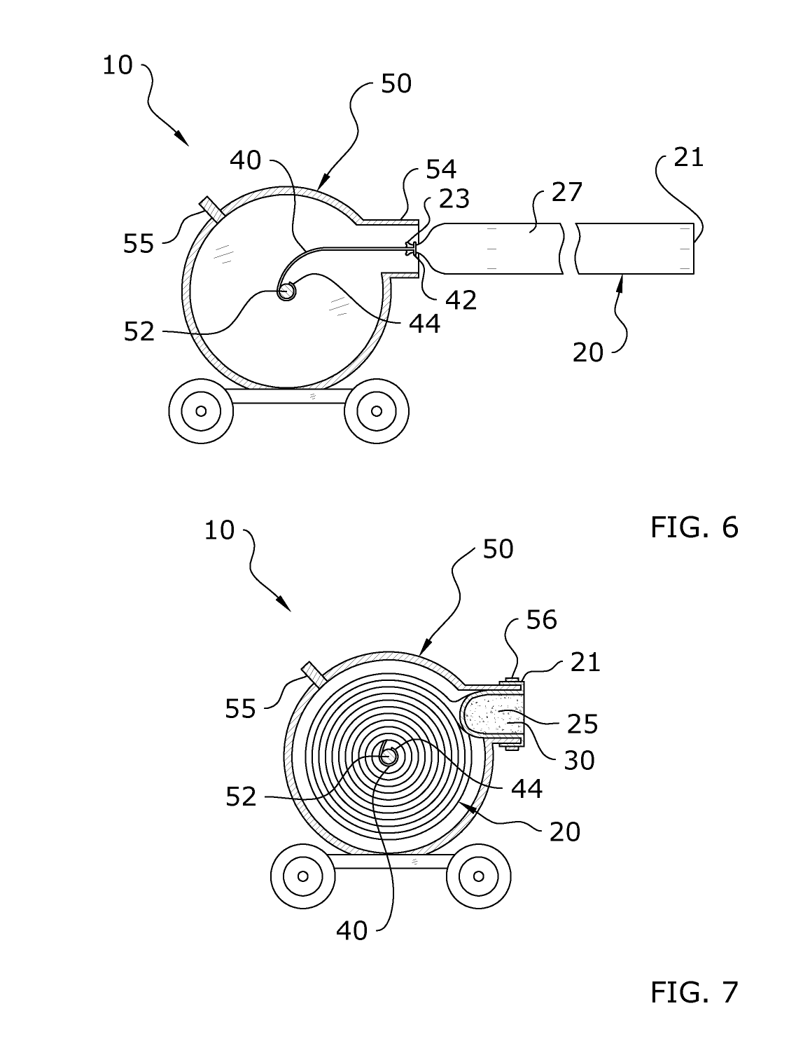

As best shown in FIG. 6, a shaft adjuster 53 is interconnected with the shaft 52 so that the shaft 52 may be rotated in both directions using the shaft adjuster 53. The figures illustrate an exemplary shaft adjuster 53 comprised of a hand wheel. However, any number of shaft adjusters 53 may be utilized. For example, a motor (not shown) may be utilized to rotate the shaft 52. The shaft adjuster 53 in some cases may be remotely controlled so that an operator of the present invention need not be in direct contact with the shaft adjuster 53 to rotate the shaft 52, such as by remote control.

The inversion unit 50 will also generally include a connector head 54 which leads to the interior of the inversion unit 50, thus providing access to the shaft 52. The connector head 54 may comprise a range of structures, shapes, sizes, and configurations. In the figures, an exemplary connector head 54 comprising a tubular configuration is shown.

The connector head 54 could be comprised of any tubular structure which is adapted to allow the tube 20 and tether 40 to be inserted therein to be wound onto the shaft 52, including a cone configuration in some embodiments. The connector head 54 will also preferably provide enough of an abutment extending from the inversion unit 50 to allow the first end 21 of the tube 20 to be secured thereon after the tube 20 has been wound onto the shaft 52 within the inversion unit.

A connector 56 may be provided for securing the first end 21 of the tube 20 onto the connector head 54 prior to inversion in a sealed manner. Various types of connectors 56 may be utilized, including the O-ring configuration shown in the figures. Connectors 56 utilized with the present invention may include rings, clamps, tape, a rope, adhesives, or any other structure or method capable of securing the first end 21 of the tube 20 around the connector head 54 as shown in the figures.

The connection between the connector head 54 and first end 21 of the tube 20 should be resilient enough to maintain a sealed connection between the tube 20 and connector head 54 even under pressure from compressed air without springing a leak or becoming otherwise structurally compromised to inhibit operation of the inversion process.

### F. Operation of Preferred Embodiment.

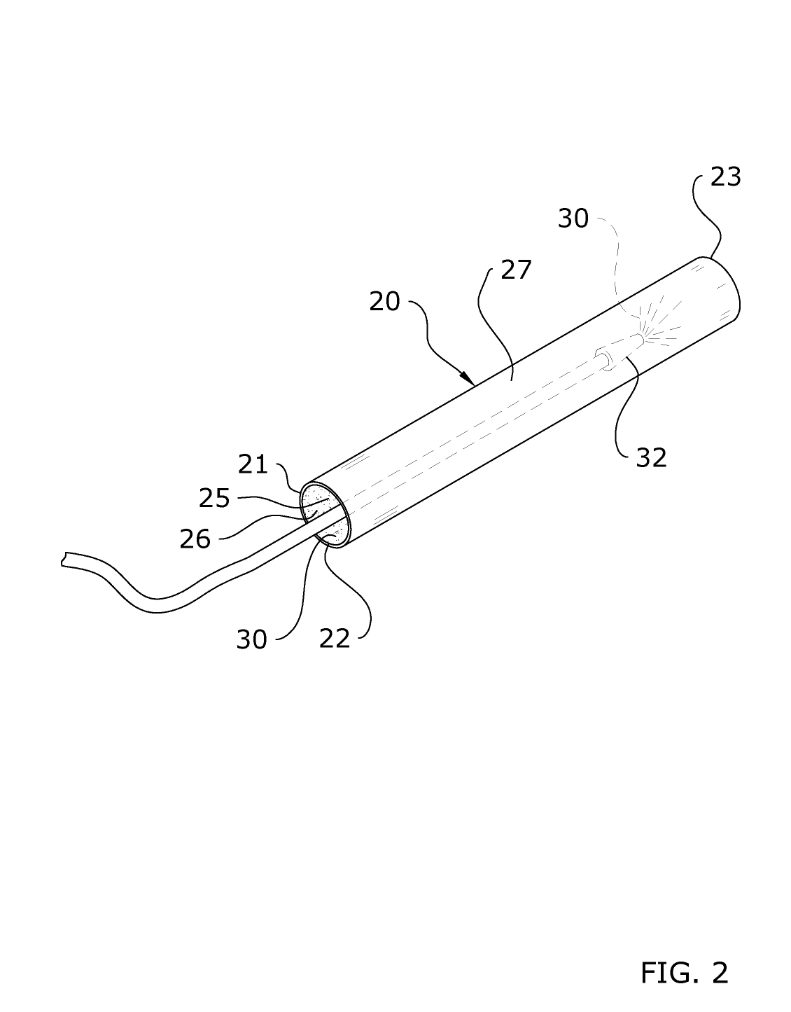

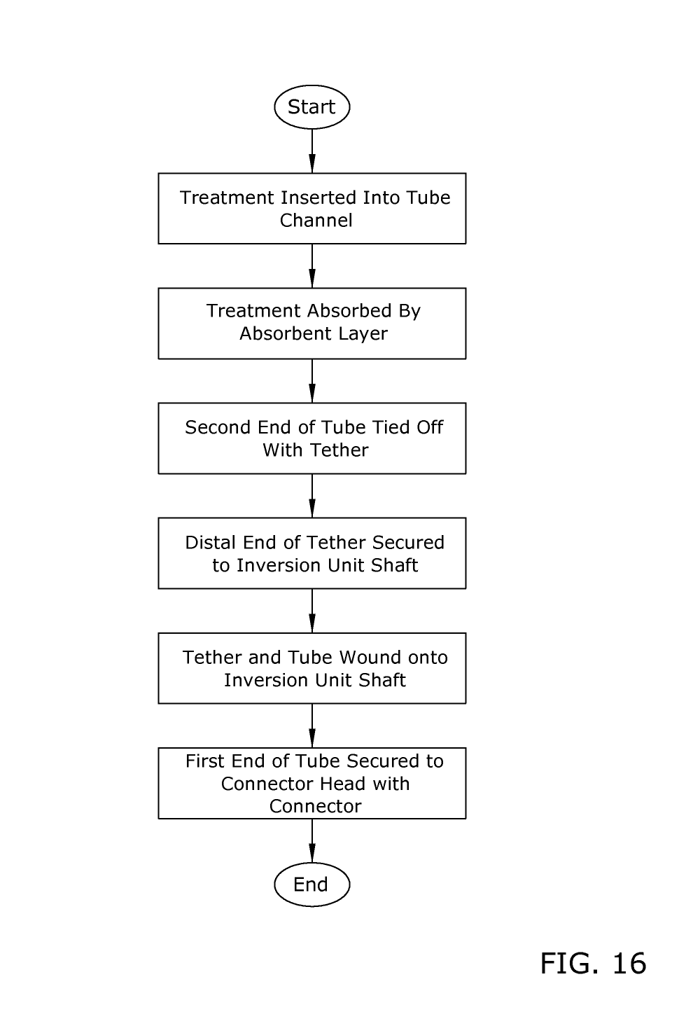

In use, the tube 20 is first laid out as shown in FIG. 1 with the second layer 27 comprising a non-absorbent material facing outwardly and the first layer 26 comprising an absorbent material facing inwardly. As shown in FIGS. 2 and 3 and illustrated in FIG. 16, the treatment 30 is then sprayed, injected, or otherwise distributed within the tube 20 so as to saturate and coat the absorbent first layer 26 of the tube 20. As noted previously, any method may be utilized for distribution of the treatment 30 within the tube 20, including spraying, pouring, injecting, and the like.

Preferably, the treatment 30 will be uniformly and evenly distributed within the tube 20 to ensure that the treatment 30 will be uniformly and evenly coated on the inner walls 13 of the conduit 12 during the inversion process of the present invention. The amount of treatment 30 utilized may vary depending on the absorption limits of the second layer 27 of the tube 20 as well as the desired quantity of coating to be applied within the conduit 12. For thinner coatings within the conduit 12, less treatment 30 will be utilized while thicker coatings will necessitate larger quantities of treatment 30 to be coated within the tube 20.

FIG. 3 illustrates a tube 20 after the first layer 26 thereof has been coated with the treatment 30. As shown therein, the treatment 30 is evenly distributed along the entirety of the first layer 26 within the tube 20 to ensure an even distribution of the treatment 30 to the conduit 12 upon inversion. It is preferable that the entire length of the tube 20 be coated with the treatment 30 to ensure even, continuous, and uniform distribution of the treatment 30 within the conduit 12 with minimal passes of the inverted tube 20.

After coating the first layer 26 of the tube 20 with the treatment 20, the second opening 24 of the tube 20 is closed off at the second end 23 of the tube 20. The figures illustrate a tether 40 being utilized to tie off the second end 23 of the tube 20 to effectuate the closing off of the second opening 24. However, as mentioned previously, other methods and devices may be utilized to close off the second opening 24 in different embodiments. In a preferred embodiment, the tether 40 will be tied around the second end 23 of the tube 20 to close off the second opening 24 completely such as shown in FIG. 4. With the second end 23 of the tube 20 closed off by the first end 42 of the tether 40, the tether 40 will be inserted through the connector head 54 and into the interior of the inversion unit 50 as shown in FIG. 5. The second end 44 of the tether 40 is secured to the shaft 52 within the inversion unit 50 as shown in FIG. 6, such as by tying or any other method.

With the second end 44 of the tether 40 secured to the shaft 52 of the inversion unit 50, the shaft adjuster 53 may be manipulated to wind both the tube 20 and the tether 40 onto the shaft 52 of the inversion unit 50 as shown in FIG. 7. In the exemplary embodiment shown in the figures, the shaft adjuster 53, comprised of a hand wheel, is turned in a first direction to wind the tube 20 and tether 40 onto the shaft 52.

With the tube 20 and tether 40 rolled onto the shaft 52, the first end 21 of the tube 20 will extend out of the connector head 54. The first end 21 of the tube 20 is rolled outwardly over the connector head 54 to effectuate the inversion process. The first end 21 of the tube 20 should be secured to the connector head 54 in a sealed manner, such as through usage of a connector 56 as shown in FIG. 7.

The connector 56, as discussed above, could comprise any device or structure which is capable of such a secured seal between the flipped-out first end 21 of the tube 20 and the exterior circumference of the connector head 54. Tape, a ring member, a clamp, or any other device may be utilized to anchor and sealably secure the first end 21 of the tube 20 to the connector head 54 as described herein. With the tube 20 and tether 40 wound onto the shaft 52 and the first end 21 of the tube 20 being anchored to the connector head 54, the present invention is ready for inversion to coat a conduit 12 as shown in FIG. 7.

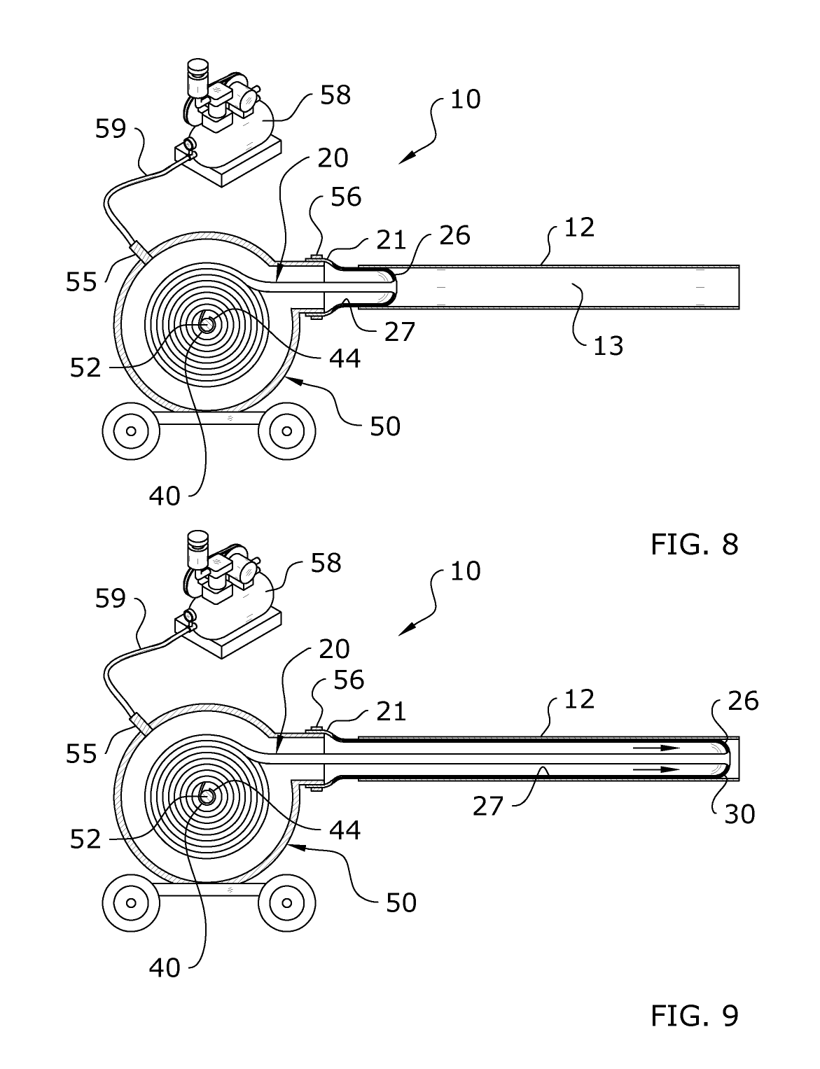

FIG. 8 illustrates the beginning of the inversion process. The inversion unit 50 is first positioned at or near the entrance to the conduit 12. It should be appreciated that the present invention may be utilized with any type of conduit 12, including piping and the like. The type of materials transported by the conduit 12 is not relevant for the present invention, as it could be used with conduits 12 adapted for transport of any materials (including liquids, solids, or gasses). Thus, the scope of the present invention should be in no way limited by the type of conduit 12 being treated.

With the inversion unit 50 positioned at or near the entrance to the conduit 12, the connector head 54 will be positioned to face the entrance of the conduit 12. The air compressor 58 is then activated to pressurize and expand the tube 20 as it exits the inversion unit 50 while the shaft 52 is rotated in a second direction (opposite to the first direction used for winding) by the shaft adjuster 53 to unwind the tube 20 from the shaft 52. Air pressure from the air compressor 58 will cause the tube 20 to invert within the conduit 12 as shown in FIGS. 8 and 9.

As the tube 20 is inverted out of the inversion unit 50, the layers 26, 27 of the tube 20 will similarly invert. Thus, under inversion, the absorbent first layer 26 will become the external layer of the tube 20 while the non-absorbent second layer 27 will become the internal layer of the tube 20. As the first layer 26 is inverted within the conduit 12, the treatment 30 on the first layer 26 will be uniformly and evenly distributed throughout the inner walls 13 of the conduit 12 as is shown in FIG. 9.

In some cases, multiple passes of the inverted tube 20 may be necessary for a full coating of the conduit 12. In such cases, the tube 20 may be extended and retracted multiple times by utilizing the shaft adjuster 53 of the inversion unit 50. Air pressure should be maintained during both extension and retraction from the air compressor 58 to ensure that the conduit 12 is thoroughly coated or treated by compressing the tube 20 against the inner walls 13 of the conduit 12.

As the shaft 52 is rotated in either direction, the tether 40, which is connected between the shaft 52 and the tube 20, will cause the tube 20 to either extend or retract within the conduit 12. FIGS. 8-11 show the tube 20 being extended and retracted in multiple passes to effectuate a uniform and complete coating of the conduit 12.

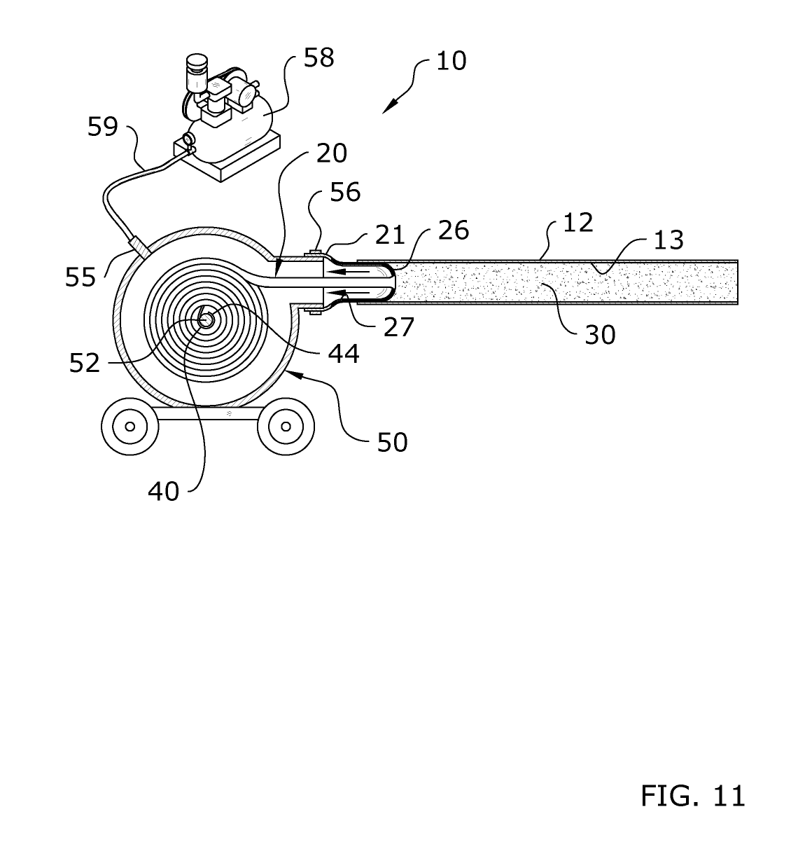

After coating, the inner walls 13 of the conduit 12 will be fully coated with the treatment 30 as shown in FIG. 15. When such operations are completed, the tube 20 and tether 40 may be wound back onto the shaft 52 by rotating the shaft 52 in the second direction. FIG. 11 shows the tube 20 being refracted and wound back onto the shaft 52 after coating. The tube 20 will preferably be continuously fed compressed air by the air compressor 58 as the tube 20 is being retracted.

If sufficient treatment 30 remains within the tube 20, the present invention will be ready for further use. If the treatment 30 has been depleted through coating the conduit 12, the tube 20 may be unwound from the shaft 52 and removed completely from the inversion unit 50 by releasing the tether 40 from the shaft 52. The tether 40 may also be removed from the tube 20 to allow the second opening 24 to be reopened for reapplication of treatment 30 within the tube 20. The aforementioned steps may then be repeated for further usage of the present invention after the tube 20 has been refilled with the treatment 30.

Depending on the type of treatment 30 used, the tube may be discarded, cleaned, or re-used. Also depending on the treatment 30, multiple coatings or treatments may be applied with the same tube 20 without the need to replace the tube 20 after each application.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A conduit treatment system, comprising:
a tube including an absorbent layer;
a treatment adapted to be absorbed by said absorbent layer;
an inversion unit for inverting said tube within a conduit, wherein said tube is wound within said inversion unit; and
a tether adapted to be connected between said inversion unit and said tube, said tube being adapted to invert such that said absorbent layer applies said treatment within said conduit.

2. The conduit treatment system of claim 1, wherein said treatment comprises a liquid solution.

3. The conduit treatment system of claim 1, wherein said absorbent layer comprises a foam material.

4. The conduit treatment system of claim 1, further comprising a non-absorbent layer.

5. The conduit treatment system of claim 4, wherein said absorbent layer comprises an inner layer of said tube when said tube is not inverted.

6. The conduit treatment system of claim 5, wherein said non-absorbent layer comprises an outer layer of said tube when said tube is not inverted.

7. The conduit treatment system of claim 1, wherein said tether is comprised of a rope.

8. The conduit treatment system of claim 1, wherein said tube includes a first end and a second end, wherein said tether is tied off on said second end of said tube.

9. The conduit treatment system of claim 8, wherein said first end of said tube is secured to a connector head of said inversion unit.

10. The conduit treatment system of claim 1, wherein said inversion unit includes a shaft, wherein said tether and said tube are adapted to be wound on said shaft.

11. The conduit treatment system of claim 10, wherein said inversion unit includes a shaft adjuster for adjusting said shaft.

12. A method of treating a conduit, comprising:
providing a tube having a first end and a second end, said tube including an absorbent layer;
inserting a treatment into said tube, wherein said treatment is absorbed by said absorbent layer;
providing an inversion unit;
securing a first end of said tube onto a connector head of said inversion unit;
securing a second end of said tube to said inversion unit with a tether; and
inverting said tube within a conduit such that said absorbent layer applies said treatment within said conduit.

13. The method of treating a conduit of claim 12, wherein said treatment comprises a liquid solution.

14. The method of treating a conduit of claim 12, wherein said absorbent layer comprises a foam material.

15. The method of treating a conduit of claim 12, wherein said tube includes a non-absorbent layer.

16. The method of treating a conduit of claim 15, wherein said absorbent layer comprises an inner layer of said tube when said tube is not inverted and wherein said non-absorbent layer comprises an outer layer of said tube when said tube is not inverted.

17. The method of treating a conduit of claim 12, wherein said non-absorbent layer comprises a plastic material.

18. The method of treating a conduit of claim 12, further comprising the step of removing said tube from said conduit.

19. The method of treating a conduit of claim 12, further comprising the step of providing an air compressor and connecting said air compressor to said air inversion unit.

20. The method of treating a conduit of claim 19, further comprising the steps of repeatedly extending and retracting said tube within said conduit under pressure from said air compressor during inversion to apply said treatment in multiple passes.
